(19) United States
(12) Patent Application Publication
(10) Pub. No.: US 2010/0017726 A1
(43) Pub. Date: Jan. 21, 2010

(54) Web Traffic Driven Information Exchange

(76) Inventors: Aaron P. Sereboff, Owings Mills, MD (US); Michael L. Kaessner, Longmont, CO (US); Christopher D. Newman, Boulder, CO (US)

Correspondence Address: HENSLEY KIM & HOLZER, LLC, 1660 LINCOLN STREET, SUITE 3000, DENVER, CO, 80264, US

(21) Appl. No.: 12/469,639

(22) Filed: May 20, 2009

Related U.S. Application Data
(60) Provisional application No. 61/054,542, filed on May 20, 2008.

(51) Int. Cl. G06F 3/00

(52) U.S. Cl. 715/747

(57) ABSTRACT

Presently disclosed is a small, easy-to-use and low-cost device and method of exchanging contact information, information on hobbies, shared interests, images, business advertising, etc., with selected individuals. The method of exchanging contact information may be used to drive users to a website to access information stored on the website. These individuals might be encountered at business or other locations such as trade shows, social functions, and entertainment events. The device is configured to exchange device IDs with other devices without exchanging other personal information. Users of the device may log into a website and download exchanged device IDs. The user may then select a level of access to personal information for each user assigned to each exchanged device ID.

### CROSS-REFERENCE TO RELATED APPLICATIONS

The present application claims benefit of priority to U.S. Provisional Patent Application No. 61/054,542, entitled “Apparatus and Method for Web-Based Contact Exchange Using Low-Cost Handheld Device” and filed on May 20, 2008, specifically incorporated by reference herein for all that it discloses or teaches.

### BACKGROUND

The internet is increasingly a place where business is conducted and internet users exchange data. However, as the internet becomes more popular and more websites are created, it becomes more difficult to drive internet traffic to a specific web page. There may be many similar web pages that also exist and directing users to a specific web page can be challenging. As a result, methods of driving traffic to particular web pages are very desirable and can be quite profitable.

At present, driving traffic to particular web pages typically consists of providing web addresses to potential users of the internet via advertising. The advertising may be in the form of word-of-mouth, print, television, and/or radio media. However, these forms of advertising often require the potential user to remember a web address or keep a paper containing a web address. Further, many websites obtain traffic by linking from other web pages that have similar content. However, it may be expensive to pay other web pages to link to a web site and linking may not provide sufficient internet traffic.

A method for exchanging business contact information or a web address for advertising or other purposes is a pre-printed business card. Recent advances in computing technology have allowed a user to update information on an electronic business card and print a small number of updated business cards. However, the business card cannot be changed once it is printed. If the information on the business card changes, a user will have to print new business cards and exchange the updated business cards with all the user's contacts to ensure that the business contacts have the most current information. There is no automatic way of updating this information.

Further, business cards are limited in the quantity and type of information that may be exchanged. Typically, the information limitation is based on the physical size of the printed business card and the minimum size text that may be printed to the business card and read from the business card. The inclusion of additional information (e.g., shared interests, favorite recipes, photographs of social, business, or entertainment events) is limited on typical business cards.

In addition, personal digital assistants (PDAs) have been used to exchange contact information via IR ports. However, transfer of information using PDAs is problematic because typically, all information associated with a contact is transferred and the method of transfer is susceptible to eavesdroppers in the same vicinity. It is well known that PDAs are costly and hence the probability that a significant number of attendants at a gathering would possess these devices is quite low. Further, the information that is exchanged between two PDAs becomes static immediately on receipt. Still further, a PDA may not be able to share all the desired information beyond simple contact information.

A technique for sharing information at a trade show is the provision of advertising material or brochures to those attending. For example, a business at a show may give out brochures with their web addresses highlighted. However, this approach is disadvantageous because the attendees may be required to transport a cumbersome number of brochures. Moreover, should the attendees actually retain the brochures, the attendees still must find the web addresses on the brochures and manually access the business's web site subsequently in order to get additional and up-to-date information.

Existing approaches to contact/information sharing generally limit the amount of information that can be exchanged with a small, low-cost medium. The amount of information is often limited to the amount of text printed on a business card sized piece of cardboard. In addition, the information exchanged is static. Once the information is transferred to the recipient, it is difficult or impossible to alter. Consequently, either the sender or the recipient is burdened with keeping the information current.

Furthermore, the information exchanged in the present state of the art is generally the same for all recipients rather than allowing for customized sharing of shared interests and contact information. For example, it might be desirable to pass only an email address to an acquaintance rather than a full address and telephone number. In addition, in social settings, it may be awkward to grant varying levels of access to multiple individuals at the same or nearly the same time.

Still further, many of the currently existing methods for information transfer require the recipient to manually enter exchanged information (e.g., a web address or e-mail address) to store that information in an electronic device or file. In addition, many of the electronic devices used or proposed for information transfer are expensive and large. This may discourage the user from carrying the device with him or her.

Some methods of transfer require equipment not generally in the possession of individual users, such as bar code and magnetic stripe readers. Additionally, some systems allow only one user ID number thus limiting the number of devices a user might have. For example, if a user were to forget his/her device, an additional device could not be supplied and linked into existing information. Many existing devices transfer entire contact lists (e.g., synchronizing software). This requires more time, battery power, and memory. Thus, the existing devices are costly and may pose a security risk because a finder of the device could access information within a lost device.

### SUMMARY

Implementations described and claimed herein utilize a method of exchanging contact information to drive users to a website to access information stored on the website.

Other implementations described and claimed herein address the foregoing problems by providing a small, easy-to-use and low-cost method of exchanging contact information, information on hobbies, shared interests, images, business advertising, etc., with selected individuals. These individuals might be encountered at business or other locations such as trade shows, social functions, and entertainment events.

A user can buy or otherwise obtain a device and immediately begin to exchange contact information with other users. Registration of use can come at any time. Denial of access to user information can come later or be changed later.

Other implementations are also described and recited herein.

### BRIEF DESCRIPTIONS OF THE DRAWINGS

FIG. 1 illustrates a block diagram of an example handheld device according to the presently disclosed technology.

FIG. 2 illustrates an initial state of three exemplary Sammie devices, Sammie 1, Sammie 2, and Sammie 3.

FIG. 3A illustrates an exchange of device IDs between Sammie 1 and Sammie 2 of FIG. 2.

FIG. 3B illustrates an exchange of device IDs between Sammie 2 and Sammie 3 of FIG. 2.

FIG. 4A illustrates an example scenario for accessing information by coupling the device 1 to a computing system.

FIG. 4B illustrates an example scenario for accessing information by coupling the device 2 to a computing system.

FIG. 4C illustrates an example scenario for accessing information by coupling the device 3 to a computing system.

FIG. 5 illustrates information that is stored on the website and accessible to John.

FIG. 6 illustrates information stored on the website accessible by an event organizer.

FIG. 7 illustrates an exemplary scenario where a local vendor with a fixed account may allow event attendees to prepay online for goods and services provided at the event.

FIG. 8 is a flowchart illustrating example operations for exchanging device IDs between two or more Sammie devices.

FIG. 9 is a flowchart illustrating example operations for connecting a user to a web server and accessing information about other users through the website.

FIG. 10 is a flowchart illustrating example operations for configuring devices for an event.

FIG. 11 is a flowchart 1100 illustrating example operations for prepaying for goods or services accessed using a Sammie device.

FIG. 12 is a flowchart 1200 illustrating example operations for restoring account settings from a lost Sammie device.

FIG. 13 illustrates an example computing system that can be used to implement the presently disclosed technology.

### DETAILED DESCRIPTIONS

In one aspect, as will be discussed in further detail below, the presently disclosed technology contemplates a device that is small, inexpensive, and that exchanges only identification numbers associated with the device. These numbers are unique to the device and are associated with user accounts on a web site used for contact information exchange, shared interest information, images, business advertising, and so forth. Each user can have multiple aliases or device IDs associated with his/her site so that multiple devices or a device that stores multiple IDs can be used.

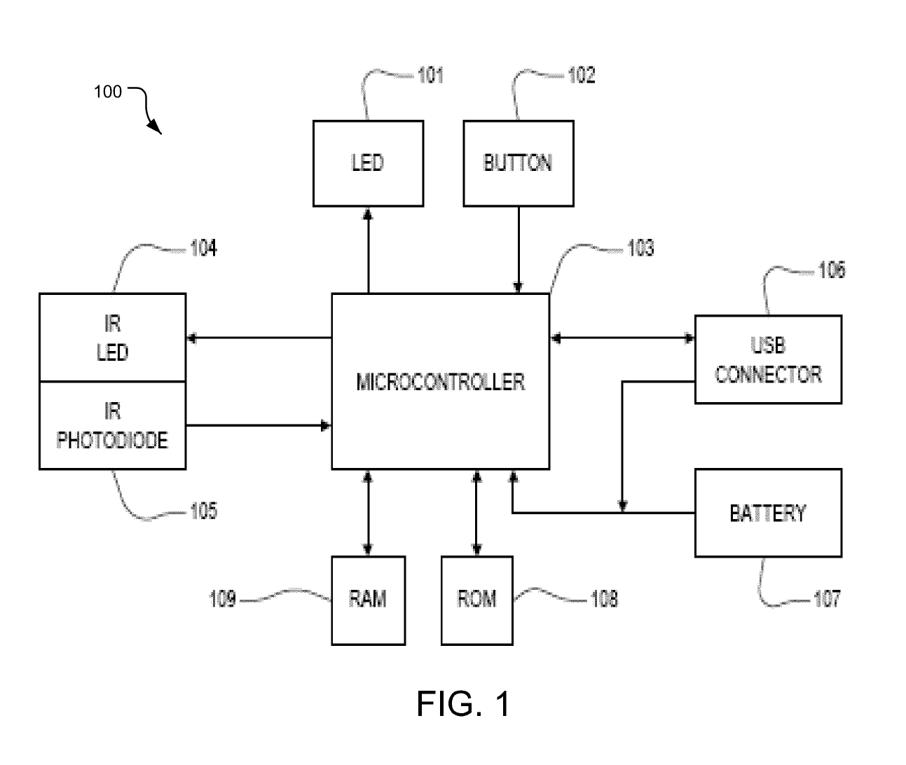

FIG. 1 illustrates a block diagram of an example handheld device 100 according to the presently disclosed technology. The device 100 includes a microcontroller 103 or microprocessor 103 that is coupled to a read-only memory (ROM) 108, such as a flash ROM 108, and to a random access memory 109. In one embodiment, the memories 108, 109 are embedded within the same integrated circuit as the microcontroller 103. The microcontroller 103 is also coupled to a push-button switch 102, a light-emitting diode (LED) 101, an infrared (IR) LED 104, an IR photodiode 105, a Universal Serial Bus (USB) connector 106, and a battery 107. However, not all implementations of the device 100 will be equipped with all of the read-only memory (ROM) 108, random access memory 109, push-button switch 102, light-emitting diode (LED) 101, infrared (IR) LED 104, IR photodiode 105, Universal Serial Bus (USB) connector 106, and battery 107 components.

In operation, one or more application programs that embody methods for exchanging information disclosed in detail below are programmed into the ROM 108 and are executed by the microcontroller 103. The RAM 109 is employed for data storage and retrieval during execution of the one or more application programs.

The switch 102 is operable by a user and the LED 101 provides visual feedback to the user. The battery 107 powers the microcontroller 103, and may be replaceable when the device 100 is operating remotely (e.g., during a trade show or similar social event). The USB connector 106 couples the device to a user's desktop computer, laptop computer, or similarly featured device, to send/receive data or recharge the device 100. When the device 100 is coupled to a computer via the USB connector 106, power for the microcontroller 103 can be provided from a USB port on the computer. In one embodiment, the battery 107 also includes charging circuitry that provides for recharge of the battery when the device 100 is coupled to the computer. In one implementation, the device 100 has multiple LEDs 101 or other indicators that correspond to multiple device IDs and/or multiple switches 102 to select the multiple device IDs.

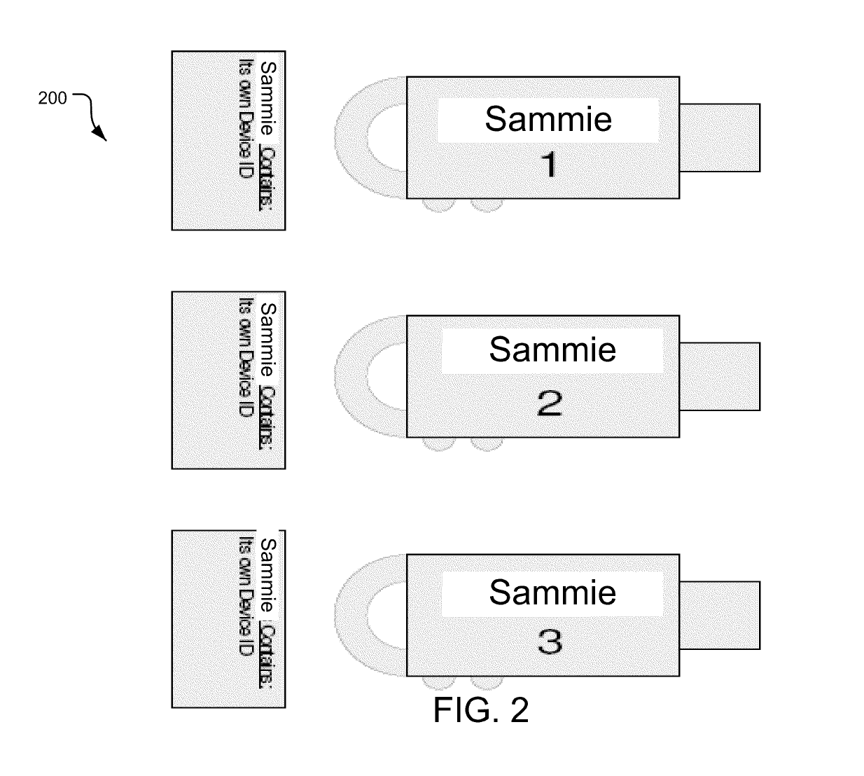

Usage scenarios for the presently disclosed technology are discussed below with reference to FIGS. 2-11. In the following discussions, the presently disclosed technology may be referred to as the Sammie.

FIG. 2 illustrates an initial state of three exemplary Sammie devices 200, Sammie 1, Sammie 2, and Sammie 3. For example, the three exemplary Sammie devices 200 are provided to attendees at a trade show. The Sammies 200 may be given to all or selected attendees at the trade show or other event. In one implementation, the three devices of FIG. 2 are assigned unique device IDs (e.g., MAC addresses) and are given to three disparate attendees. The devices 200 may not contain any actual contact information for their respective users.

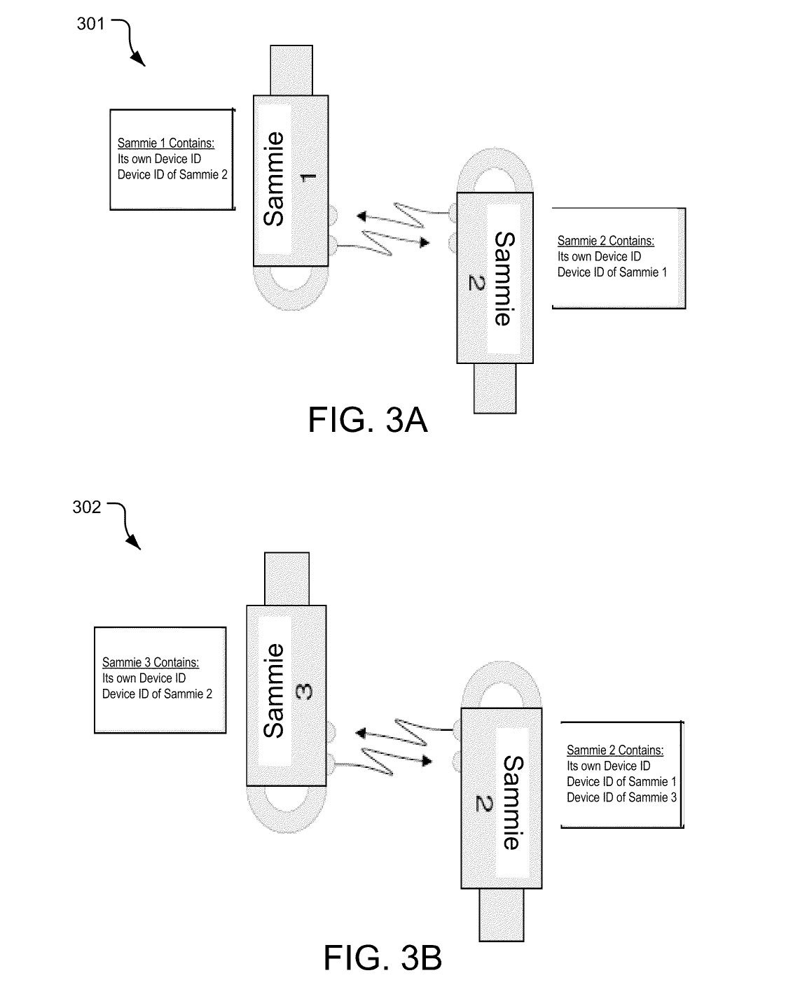

FIG. 3A illustrates an exchange 301 of device IDs between Sammie 1 and Sammie 2 of FIG. 2. In the exchange scenario 301, a User 1 and a User 2 decide that they want to be able to contact each other after the event, so they “connect” with each other by activating a switch and observing visible feedback from an LED on their respective devices. An IR LED on each device transmits the its device ID and a photodiode is employed to receive transmitted information from the other device. Thus, following transmission and reception of device IDs, each of the devices now contains the other device's ID number.

In one implementation, there are multiple switches on each device corresponding to unique device IDs. For example, one device ID may be associated with a user's personal profile. A second device ID may be associated with a user's business profile. By providing the ability to select a device ID associated with a specific profile, the user may more effectively allow access to personal information appropriate to his/her new contact.

FIG. 3B illustrates an exchange 302 of device IDs between Sammie 2 and Sammie 3 of FIG. 2. Similar to exchange scenario 301, in scenario 302, the User 2 and a User 3 execute an exchange of device IDs. Thus, following the exchange scenario 301, Device 3 now contains the device 2 ID number, and device 2 adds the device 3 ID number to the device 1 ID in memory.

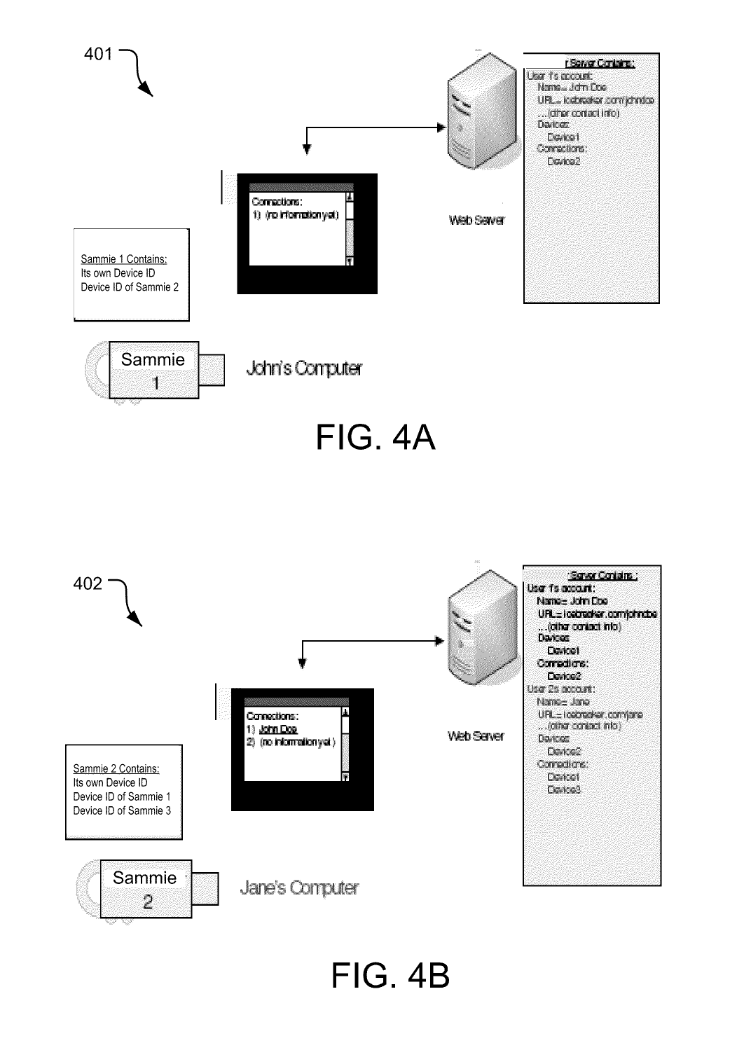

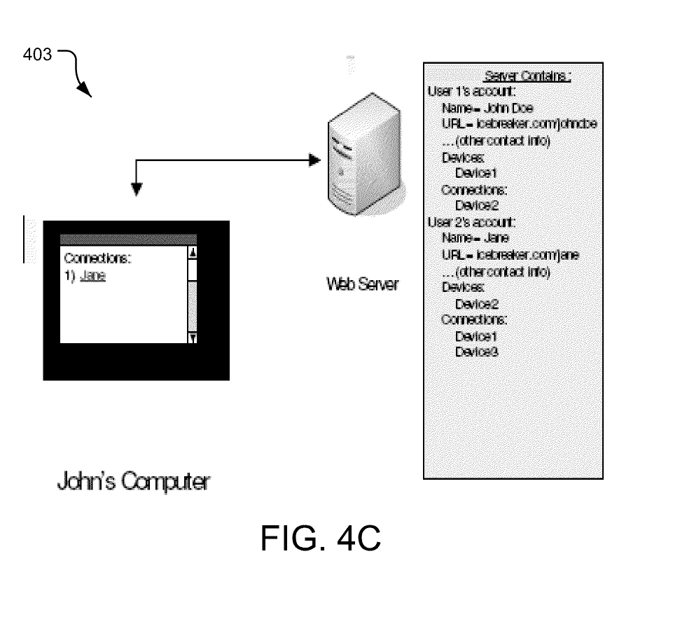

FIG. 4A illustrates an example scenario 401 for accessing information by coupling the device 1 to a computing system. In scenario 401, User 1 (John) arrives home first, plugs the device 1 into his computer, which takes him to a website that is configured to store user information and to control access to the stored information. The device 1 ID(s) and exchanged device IDs stored in device 1 are uploaded to the website. John creates an account, or logs into an existing account. The device 1 ID number(s) are now associated with John's account. John's account indicates that he connected with one person (User 2), but that person does not yet have any information associated with their device, so he is advised to check back later.

FIG. 4B illustrates an example scenario 402 for accessing information by coupling the device 2 to a computing system. In scenario 402, and in like manner, User 2 (Jane) arrives home and couples her device (device 2) to her computer. Her device ID(s) and exchanged IDs are uploaded to the website. Jane additionally adds information to her account. After uploading her exchanged IDs, Jane can now see John's (user 1) information, but not user 3 information.

FIG. 4C illustrates an example scenario 404 for accessing information by coupling the device 3 to a computing system. In scenario 403, John subsequently returns to the website and is able to access Jane's information that she provided in scenario 402.

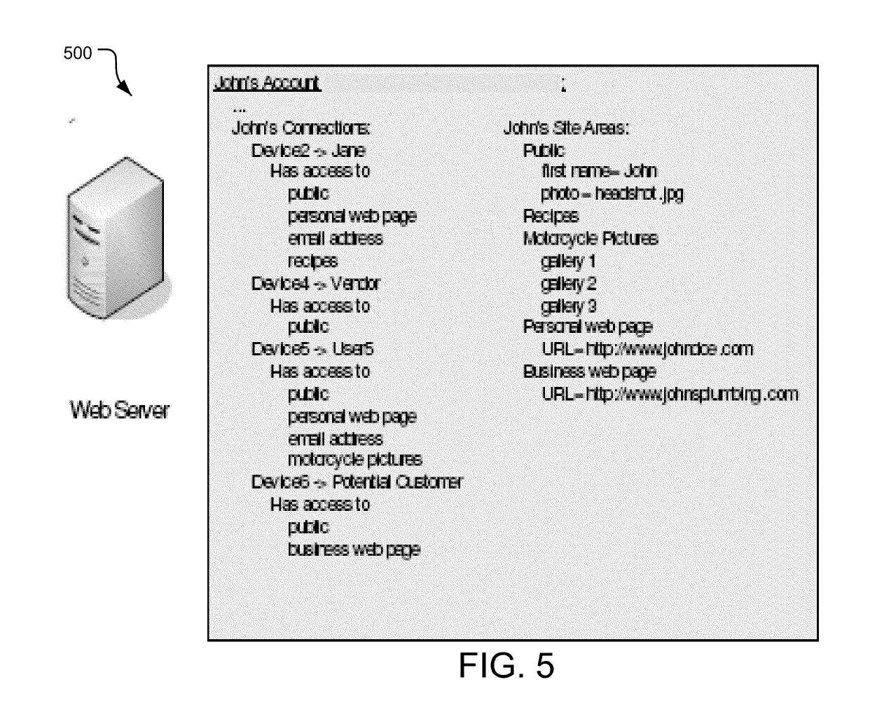

FIG. 5 illustrates information 500 that is stored on the website and accessible to John. For example, the details of John's account show that he now has connections with four people (corresponding to devices 2, 4, 5, and 6). Further, John has added some pictures, recipes, and links, and has given users access to different areas of his site.

In one embodiment, users that John connects with by default only have access to his public area, which just has his first name and a picture of him. Jane showed interest in John's recipes, so John used the web interface to give her access to his recipes. John also gave Jane access to his email address and personal web page. In addition, John connected with a vendor with Device 4 while at the trade show. Since John does not want to be contacted by the vendor, he left that connection in its default state, which only gives the vendor access to John's first name and picture. In one embodiment, the vendor's account (not shown), gives everyone access to the vendor's product information. Therefore, John can get what he needs from the vendor.

Furthermore, the diagram 500 shows that John later met user 5. User 5 was interested in John's motorcycle, so John gave user 5 access to his motorcycle pictures. Moreover, John also met user 6 who is interested in hiring John. Thus, John gave user 6 access to John's business web page.

Multiple device IDs may be provided on a Sammie device to customize user information to be presented to various groups of contacts. For example, one device ID may correspond to a personal user profile and another device ID may correspond to a business user profile.

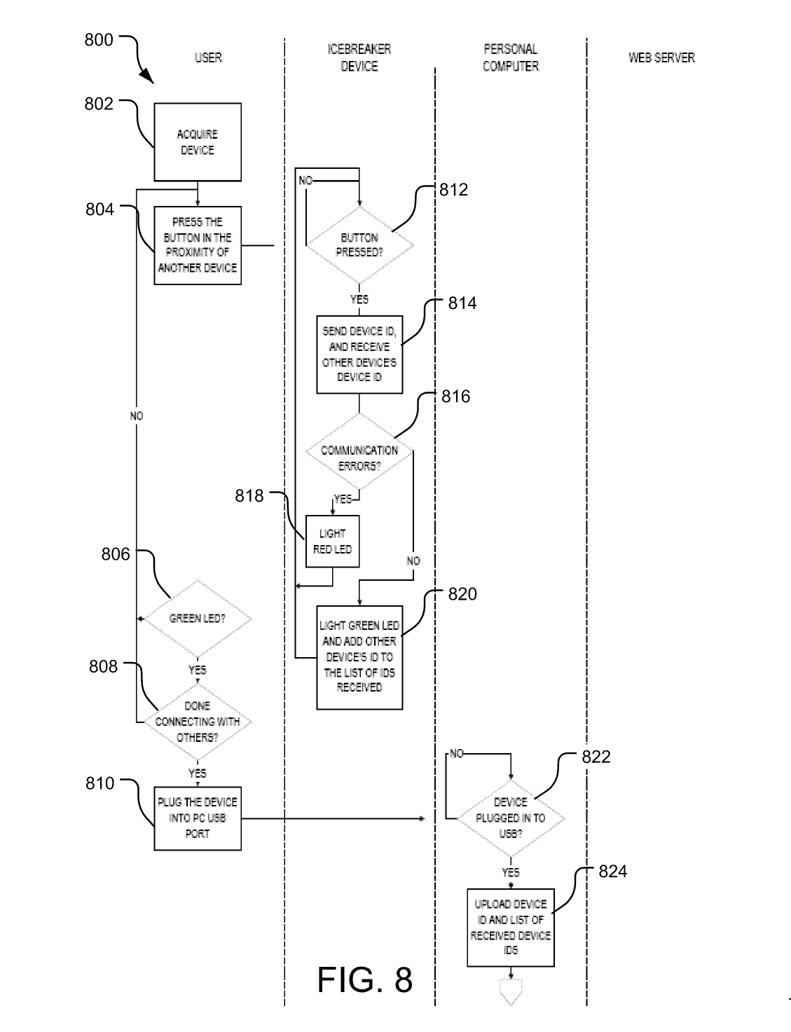

The content of FIGS. 2-5 is further described with respect to a method for connecting users in the flow chart 800 of FIG. 8.

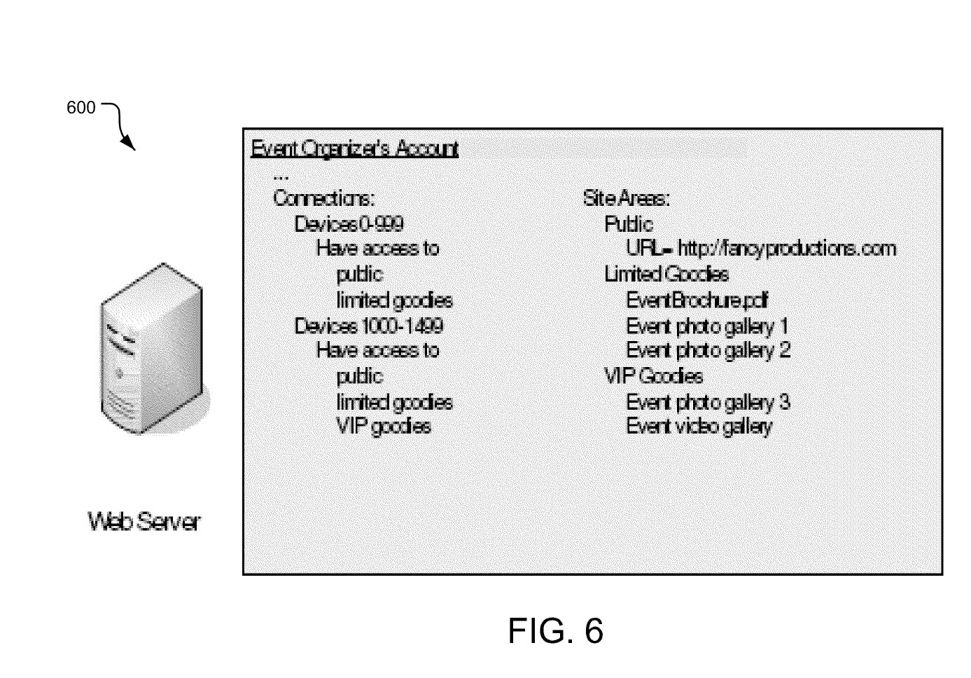

FIG. 6 illustrates information 600 stored on the website accessible by an event organizer. The event organizer provides access to information regarding an event. Buyers of more expensive event tickets are provided devices out of the box numbered 1000-1499, which give access to a special VIP area of the site. Those which have purchased less expensive tickets are given devices 0-999, which restrict access to only public information and limited take-home items.

In one embodiment, an event organizer might give Sammie devices to all ticket buyers. Since the event organizer is not required to physically connect with each of the devices, the event organizer can program the event organizer account to provide different levels of access to different ticket buyers. While only two access levels are shown in FIG. 6, the presently disclosed technology contemplates more than two levels of access and privileges.

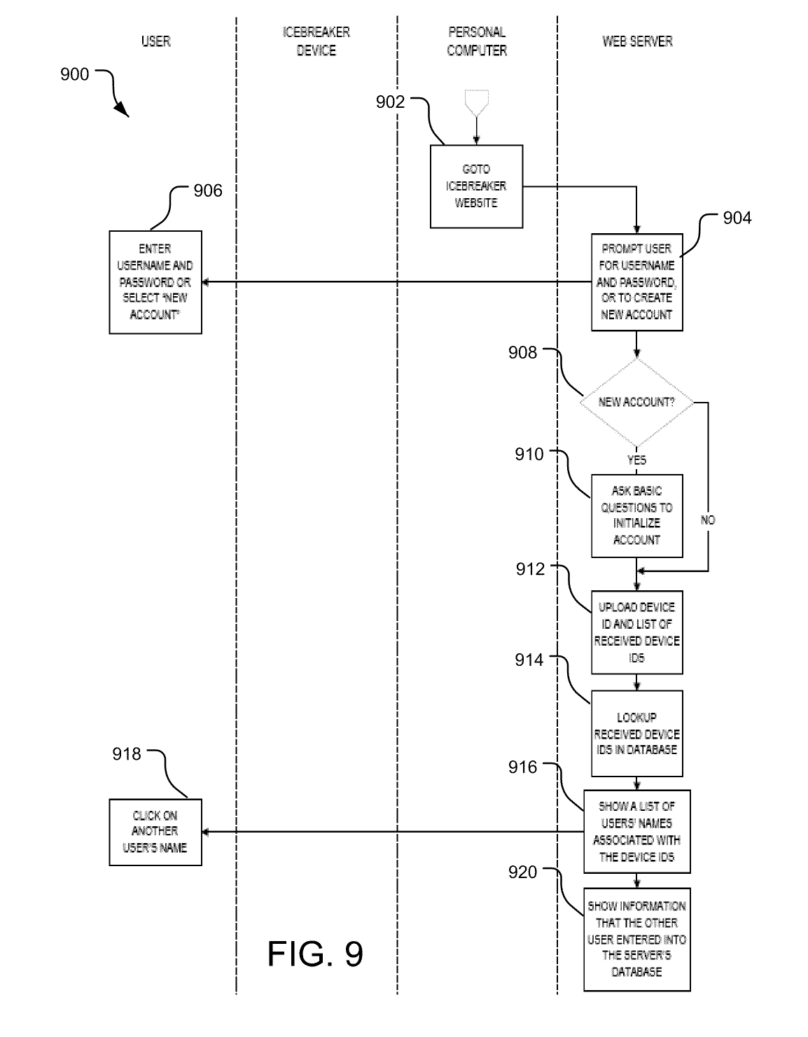

The content of FIG. 6 is further described with respect to a method for configuration of the devices for an event in the flow chart 900 of FIG. 9.

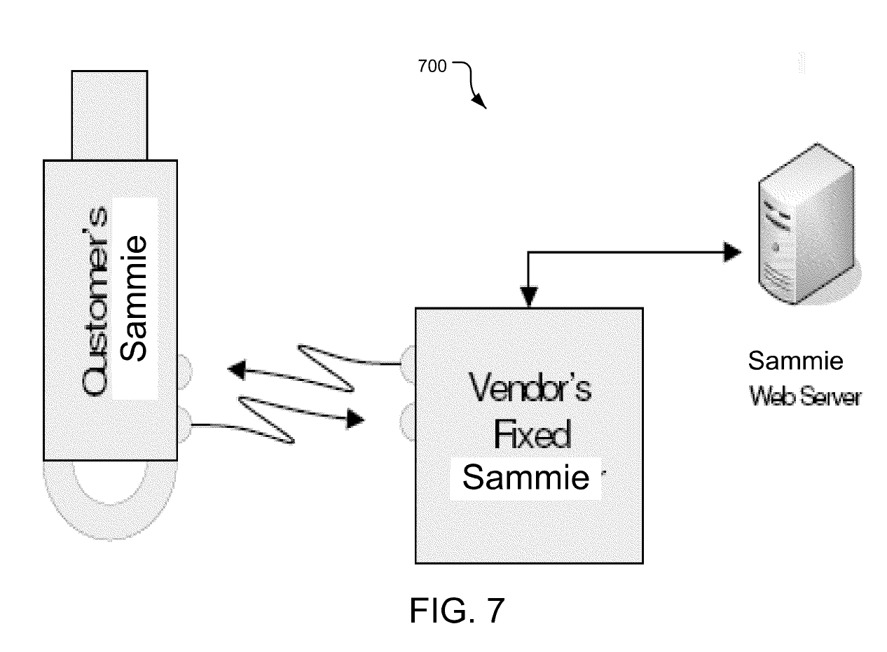

FIG. 7 illustrates an exemplary scenario 700 where a local vendor with a fixed account may allow event attendees to prepay online for goods and services provided at the event. For example, an attendee (e.g., a customer) might prepay for goods or services online prior to an event, and then redeem the goods and services locally. For instance, the user might buy tickets to the event online through the user's Sammie account that is associated with the user's device. When the user arrives at the event, the user does not need to wait at will-call. Instead, the user simply connects his/her device with the event's fixed Sammie device where tickets are taken. One advantage of this technique is that a paperless method for admission is provided, which is commonly assumed to be environmentally friendly. This advantage may be particularly desirable in certain social situations where the so-called “Green” movement is popular.

Customers who buy goods or services (e.g., coffee) could also use the scenario 700 of FIG. 7. For example, customers that frequently use a particular vendor and want to prepay a certain number of dollars can have the purchase amount deducted automatically the customer's account. This provides the vendor with an opportunity to provide incentives for large deposits. Further, the customer is not required to carry money or credit cards, which are both subject to theft.

In another example of the scenario 700 of FIG. 7, coupons received through e-mail or on a website could be associated with the customer's device. Grocery stores could use the customer's device as a method of tracking buying trends (similar to how grocery stores currently use club cards), without issuing club cards. If the customer's Sammie device is lost or stolen, the customer's account can easily be associated with a new Sammie device. The lost or stolen device can then be deactivated without requiring any action by the vendor. The device discussed in the scenarios of FIGS. 2-7 may be a very low cost device that can easily be replaced by a device provider. Such an approach is highly advantageous over other more costly devices for information exchange (e.g., PDAs).

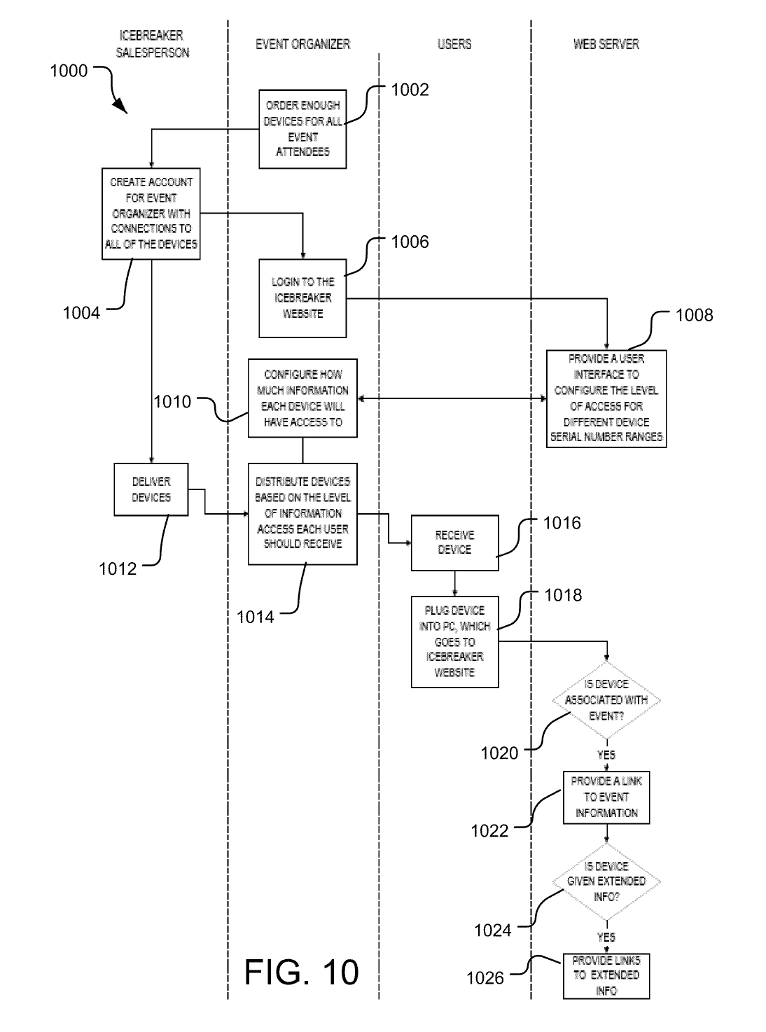

The content of FIG. 7 is further described with respect to a method for prepaying online for goods and/or services in the flow chart 1000 of FIG. 10.

Additional scenarios where devices according to the presently disclosed technology could be employed include; prepaid coffee or food, prepaid copies, email or online coupons, ski lift tickets, concert tickets, monthly bus passes (if the passes periodically download a list of valid devices), and gym memberships.

FIG. 8 is a flowchart 800 illustrating example operations for exchanging device IDs between two or more Sammie devices. A user acquires a Sammie device at a tradeshow or other event 802. The device is configured with at least one ID that is specific to the device. If multiple IDs are stored on the device, a selector such as a switch or button may be used to select one of the stored IDs and then transmit the selected ID to another device. The user activates a button on the device in the proximity to a second device possessed by second user at the event 804. If a green indicator light on the device illuminates, the device has successfully exchanged device IDs with the second device 806.

From the perspective of the Sammie device, when the user activates the button 812, the device sends its device ID and receives any device IDs within its range 814. If there are any communication errors 816 resulting in a failure to send or receive the device IDs, a red light will illuminate 818 and the user will have to activate the switch again to restart the process. If the device ID is successfully sent and all device IDs within range are received, the green light will illuminate indicating the successful transmission of device IDs 820.

When the user is done connecting with other users 808 and returns from the event to an area with a personal computer (e.g., his/her hotel room, office, and home), the device may be plugged into the personal computer 810, 822. In some instances the device utilizes a USB connection, however other connections are contemplated (e.g., wi-fi, Bluetooth, and memory card). The device ID of the user's device and a list of received device IDs from other devices are uploaded to the computer 824.

FIG. 9 is a flowchart 900 illustrating example operations for connecting a user to a web server and accessing information about other users through the website. Users of a Sammie device may access a Sammie website 902. The website may prompt the user to enter a username and password or alternatively select a “new account” option 904. Existing users log on to the Sammie website using a username and a password. New Sammie users may select a “new account” option 908. If the user selects a “new account,” the website will prompt the user to enter basic information needed to create a new account 910. This information may include, but is not limited to name, address, phone number, credit card number, username, and password. This information may also reference an event instead of a specific user and the information may be referred to collectively as a target identifier.

Once the new account is activated or the user signs into an existing active account, the user may upload device IDs to the website 912 in the manner described with respect to FIG. 8. The website may then lookup the received device IDs in a database that associates user names with their respective device IDs 914. The user is then presented with a list of user names associated with the device IDs that he/she received 916. The list of user names may also include pictures or brief descriptions of each user to aid the user in remembering each user with which he/she exchanged device IDs. The user may then select one or more of the user names 918 to display information that the user has previously entered into the Sammie website 920.

FIG. 10 is a flowchart 1000 illustrating example operations for configuring devices for an event. An event organizer approaches a Sammie sales representative or other authorized person about supplying devices for attendees of the event 1002. The sales representative may then obtain sufficient devices for the event and create an account for the event organizer within the Sammie website that grants at least limited access to all the devices intended to be used at the event 1004. The event organizer can then log onto the Sammie website 1006 to configure a level of access for various device IDs 1008, 1010. For example, the event organizer may desire to have several groups of devices with varying levels of access intended to be provided to several groups of event attendees. Alternatively, the event organizer may configure all the devices to have the same level of access.

Once the devices are delivered to the event 1012, the devices can be distributed based on a level of access to information that each attendee of the event should receive 1014. After the attendees receive 1016 and use the devices at the event as described at least with respect to FIG. 8, the attendees may plug their respective devices into personal computers to download device IDs to the computers and the attendees can access the Sammie website 1018. When the attendees access the Sammie website, the website searches to see if the attendees device is associated with a specific event 1020. If so, the attendee is provided with a link to event information 1022. Further, the website determines the attendee's level of access based on the device ID 1024 and grants the attendee access based on the device ID 1026.

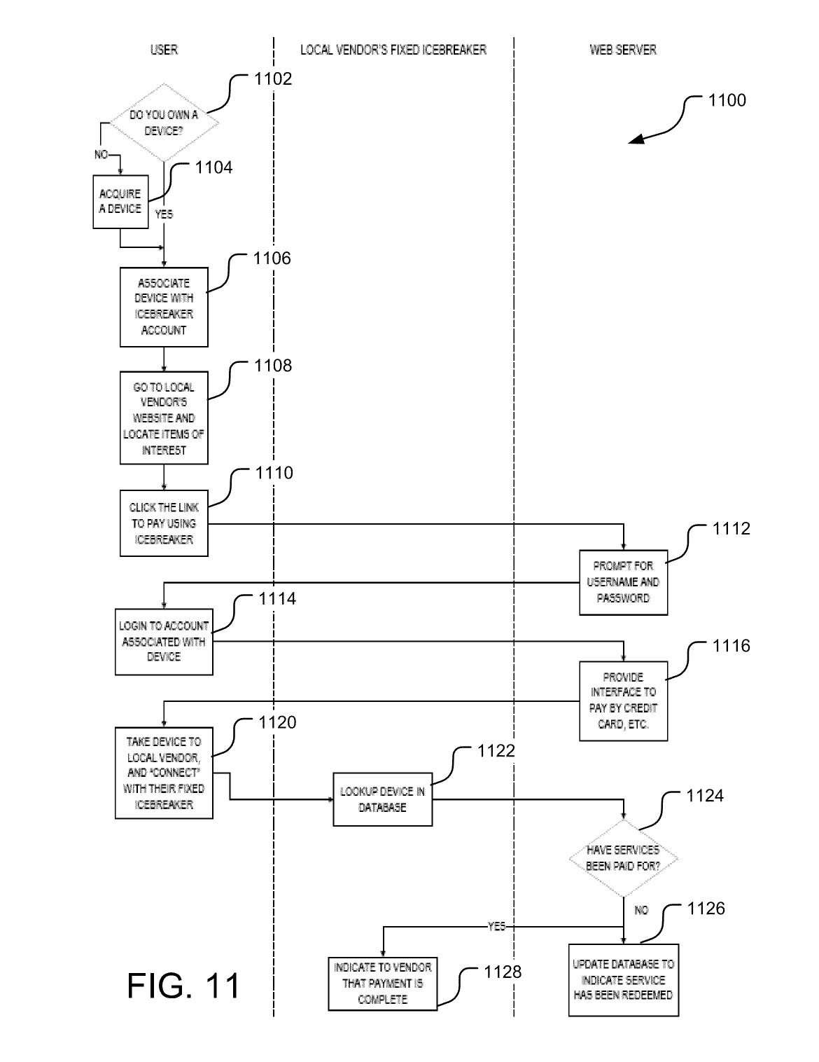

FIG. 11 is a flowchart 1100 illustrating example operations for prepaying for goods or services accessed using a Sammie device. If a user already owns a device 1102, the device is associated with the user's Sammie account 1106. Otherwise, the user obtains a device and the new device is associated with the user's Sammie account 1104. Then the user accesses a vendor's website and locates one or more items of interest 1108. If the user decides to purchase one or more of the vendor's items, the user selects a “pay link” on the vendor's website that allows the Sammie to be used for payment 1110. The website prompts the user to provide a username and password to login to the user's Sammie account 1112. After the user logs in in operation 1114, The Sammie account provides the vendor's website an interface with which to pay for the desired items (e.g., credit card, debit card, and PayPal®) 1116.

The user then may take his/her device to a local vendor of the desired items and “connect” the user's device with a fixed Sammie device at the vendor's physical location 1120. The user may also access a kiosk with the desired items and “connect” the user's device with a fixed Sammie within the kiosk. The vendor may then automatically or manually look-up the user's device in a database 1122 that indicates what services or products have been paid for in operation 1124. The vendor may then provide the paid-for products or services to the user and indicate to the vendor website that the products or services have been delivered 1126. The user may also provide additional payment to the vendor and the vendor may indicate the additional payment to the vendor website 1128.

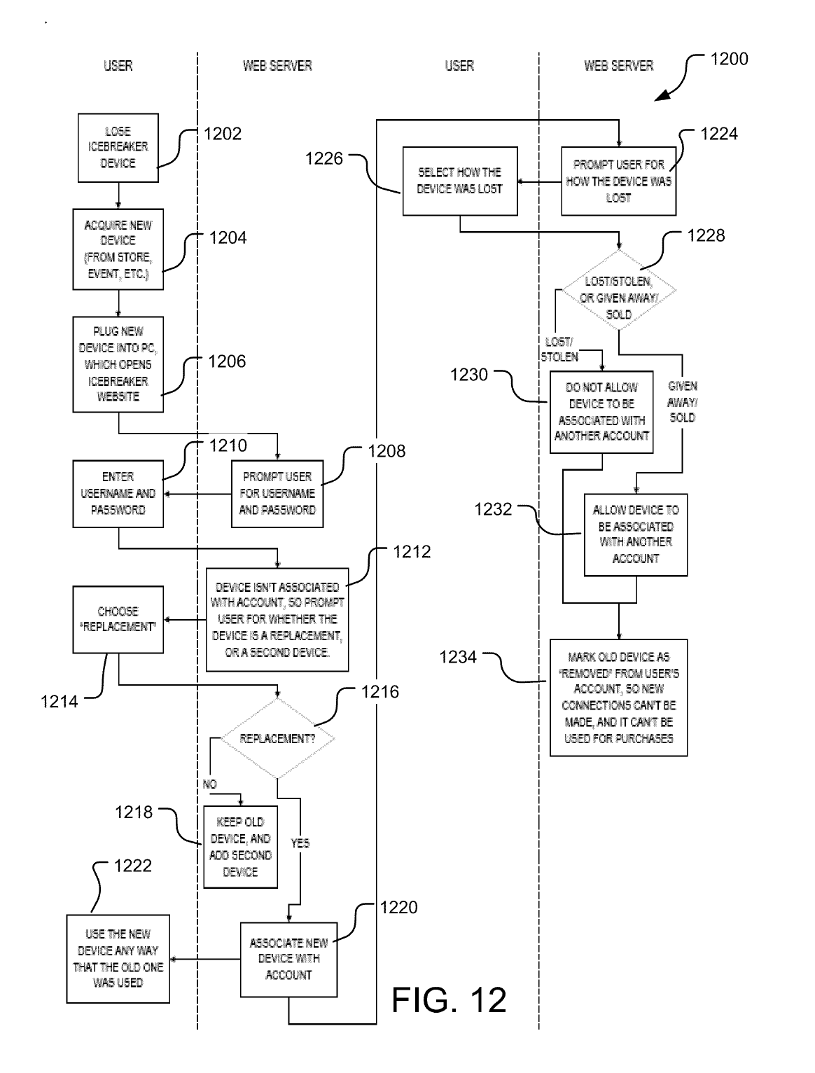

FIG. 12 is a flowchart 1200 illustrating example operations for restoring account settings from a lost Sammie device. At some point, a user may lose his/her Sammie device 1202. The user may then acquire a new device from a Sammie vendor 1204. The user plugs the new device into the user's personal computer and opens the Sammie website 1206. The Sammie website prompts the user to enter his/her username and password 1208. After the user's username and password are entered 1210, the Sammie website recognizes that the device plugged into the user's computer is not associated with the user's account 1212. The Sammie website then prompts the user to select whether the device is a “replacement device” or a “second device” 1216. If the user selects the “second device” option, the Sammie website keeps the old device and adds the new second device to the user's account 1218. If the user selects the “replacement device” option 1214, the Sammie website associates the user's account with the new device in operation 1220 and allows the new device to be used in the way that the lost device was used 1222.

The Sammie website may then prompt the user to provide the status of the first device 1224. For example, the device may have been lost, stolen, given away, or sold 1228. The user may select one of these options 1226. If the device was lost or stolen, the Sammie website will not allow the device to be associated with another account 1230. If the device was given away or sold, the Sammie website will allow the device to be associated with another account 1232. Regardless, the first device is removed from the user's account and the user can no longer use the first device to make new connection or make new purchases 1234.

One embodiment of the presently disclosed technology is a single device that is capable of multiple Device IDs that the user could associate with different amounts or types of information. For example, when connecting with other users, the user would select which Device ID to use to suit the situation. For example, a user could have a web page with his favorite recipes that he wants to share with as many people as possible; however, he does not want all of those people to be able to email him.

A further embodiment contemplates an interest-based approach. After visiting the website and setting up a profile, a list of codes that indicate interests could be downloaded to the device. Then, when the user connects with someone with similar interests, the device could indicate that they are a “match”. It is also possible to have a limited number of codes to identify interests (e.g., gardening, hiking, stamp collecting, and bird watching) amongst users if desired.

Unlike most computer peripherals, the device may not require the user to install a driver or run an executable program. Therefore, the Sammie device is virus resistant. In one implementation, when the user plugs the device into his/her computer, the device integrates like a read-only USB flash drive that contains one file that is an internet shortcut. The operating system recognizes this file and prompts the user to follow the link. The internet shortcut contains a single parameter that is passed to the web server that contains the entire encrypted contents of the device. The link will also take the user to the web site where the user can create an account and enter information. The link may look something like this: http://Sammie.com/upload.php?contents=1GU0EKCN433JV98656ENC983BD91HRBV89E93 HJNVYROHUIRHG8483HF84GWOLS903HFVC8EHGF9ETR76593JF87EFEWBFD76FC54 VGF7452VBF85GY08JKJH9BYTDT3SFS56CX46R85H568BG4H77G9JH4BG8DG385HFFB 10SDKJW8DHEWOGHVNBDE93HF3G9FG4BV7V6E74BJ2B3H59R496HG554W4RJ9. The device could also connect to any executable program such as an API (application programming interface).

In addition to the IR communication approach that is discussed with specificity herein, the presently disclosed technology also comprehends other techniques for inter-device communication to include any other communication method such as a physical connector, or radio frequency such as Bluetooth, Wi-Fi, Zigbee, or even a proprietary communication protocol.

A further embodiment comprehends a device that is configured as a memory card such as Compact Flash (CF) or Secure Digital (SD) that plugs into another processing device. Like the USB version, the device would appear to software as a memory card with files on it, so any device that can make the files on its card accessible by a computer may work. The types of other processing devices include, but are not limited to, MP3 players, PDAs, and wireless phones. The card itself could have the standard application program and methods embodied thereon, and furthermore may include a button switch to initiate a connection as described above.

In a further embodiment, the device and methods according to the presently disclosed technology may be embodied as a JAVA (or other portable language) software application running on a wireless phone. As such, the phone's short-range communication methods (e.g., Bluetooth or infrared), unique identifier (e.g., ESN or IMEI), and memory would be employed to effect connection and transfer of data.

Potential advantages of the presently disclosed technology include one or more of the following. Multiple user IDs can be allowed on each device. Exchange security is protected because only a user ID or token is exchanged, not the actual data itself. The recipient of a device ID “exchange” simply has the other user's device ID and can be precluded from accessing any information associated with the providing user until that user registers his/her device. The user information is not stored in the device. When a user receives a device at an event, the user can immediately start “connecting” with people, rather than requiring access to a computer to enter his/her information first. If a device is reported lost or stolen, the website can disallow the device from being re-registered. If someone finds the old device, the information and prepaid values will remain secure. A vendor could check a picture on the user's web site to compare it with the person to return a lost device to a user. If a user loses his device, none of his information or prepaid values is lost because that information is not stored on the device.

The devices need very little memory and user interface software and are therefore inexpensive. If a user connects with a vendor, he/she can decide later whether or not to give the vendor access to his contact information. An event organizer that gives the devices to ticket buyers can give the devices information and access without having to physically connect to the devices. If the device is replaced, all information is secure and associated with the new device, without requiring any action by the vendor. Without having to open an account locally with a particular vendor, a user can pay for local goods and services online using the device.

If an event organizer gives additional access to certain users, each device can only be associated with one account. A user must be logged in to his/her account to access the additional content, so only one person can gain access using the device provided. This prevents hackers from posting links to the protected content.

Each user has a table of contacts stored on the web site that has entry points to information he/she has prepared to exchange. For each contact, he/she creates a list of these entry points that the other user can access. This list can change over time.

The system has the capability to point to another web site for advertising or additional information. Thus at a trade show, a vendor might beam his “shared information” to a passing attendee who could then access the requested information on the vendor's web site.

Given the simplicity of the device, another embodiment contemplates an add-in device can be added to a cell phone or PDA to achieve the same functionality as the low-cost dedicated devices.

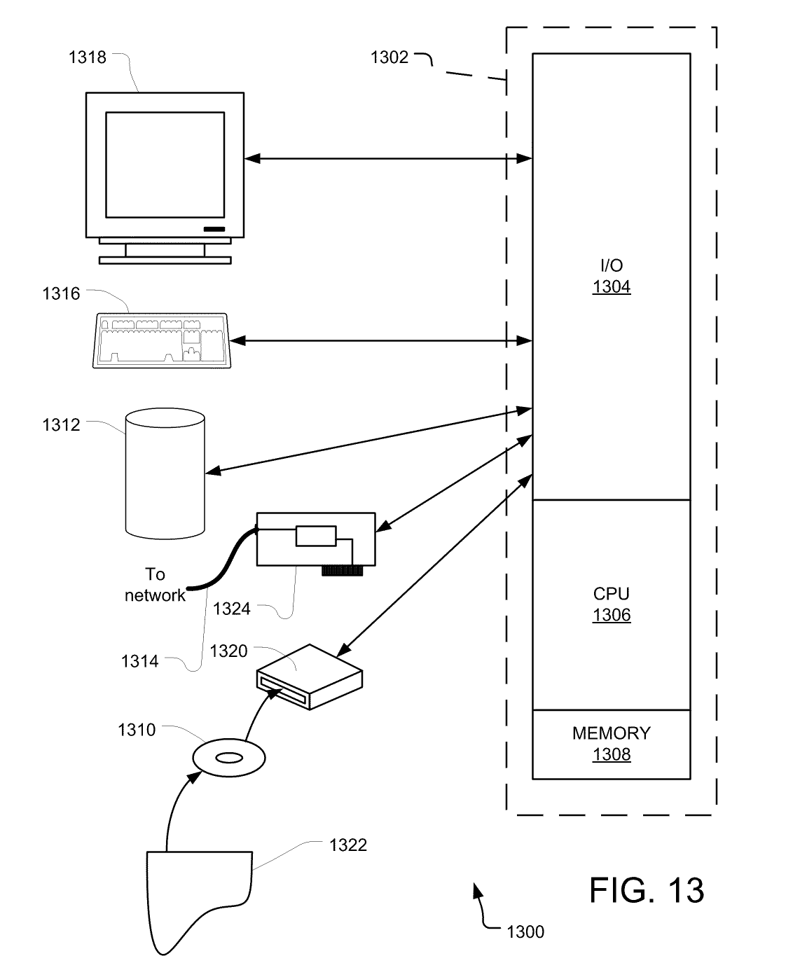

FIG. 13 illustrates an example computing system that can be used to implement the described technology. A general purpose computer system 1300 is capable of executing a computer program product to execute a computer process. Data and program files may be input to the computer system 1300, which reads the files and executes the programs therein. Some of the elements of a general purpose computer system 1300 are shown in FIG. 13 wherein a processor 1302 is shown having an input/output (I/O) section 1304, a Central Processing Unit (CPU) 1306, and a memory section 1308. There may be one or more processors 1302, such that the processor 1302 of the computer system 1300 comprises a single central-processing unit 1306, or a plurality of processing units, commonly referred to as a parallel processing environment. The computer system 1300 may be a conventional computer, a distributed computer, or any other type of computer. The described technology is optionally implemented in software devices loaded in memory 1308, stored on a configured DVD/CD-ROM 1310 or storage unit 1312, and/or communicated via a wired or wireless network link 1314 on a carrier signal, thereby transforming the computer system 1300 in FIG. 13 to a special purpose machine for implementing the described operations.

The I/O section 1304 is connected to one or more user-interface devices (e.g., a keyboard 1316 and a display unit 1318), a disk storage unit 1312, and a disk drive unit 1320. Generally, in contemporary systems, the disk drive unit 1320 is a DVD/CD-ROM drive unit capable of reading the DVD/CD-ROM medium 1310, which typically contains programs and data 1322. Computer program products containing mechanisms to effectuate the systems and methods in accordance with the described technology may reside in the memory section 1304, on a disk storage unit 1312, or on the DVD/CD-ROM medium 1310 of such a system 1300. Alternatively, a disk drive unit 1320 may be replaced or supplemented by a floppy drive unit, a tape drive unit, or other storage medium drive unit. The network adapter 1324 is capable of connecting the computer system to a network via the network link 1314, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, gaming consoles, set top boxes, etc.

When used in a LAN-networking environment, the computer system 1300 is connected (by wired connection or wirelessly) to a local network through the network interface or adapter 1324, which is one type of communications device. When used in a WAN-networking environment, the computer system 1300 typically includes a modem, a network adapter, or any other type of communications device for establishing communications over the wide area network. In a networked environment, program modules depicted relative to the computer system 1300 or portions thereof, may be stored in a remote memory storage device. It is appreciated that the network connections shown are exemplary and other means of and communications devices for establishing a communications link between the computers may be used.

The embodiments of the invention described herein are implemented as logical steps in one or more computer systems. The logical operations of the presently disclosed technology are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method for directing users to access content on a web page comprising:
storing information regarding a target identifier on a database accessible through a web page;
selecting a portion of the information on the database that the device may access through the web page; and
providing the device to a second user, wherein the second user can only access the selected portion of the information on the database through the web page.

2. The method of claim 1, wherein the selecting operation configures a first group of device IDs with a first access level to the information and a second group of device IDs with a second access level to the information, wherein the first access level is different from the second access level.

3. The method of claim 1, wherein the information includes payment data.

4. The method of claim 1, wherein the information includes contact data.

5. A method for providing selective access to information specific to a first user, the method comprising:
receiving personal information specific to the first user;
receiving a device ID associated with the first user from a second user; and
providing a portion of the personal information specific to the first user to the second user based on information access settings set by the first user using a processing unit.

6. The method of claim 5, wherein the personal information includes payment data.

7. The method of claim 5, wherein the personal information includes contact data.

8. The method of claim 5, wherein the receiving operations and providing operation are conducted through a website.

9. The method of claim 5, wherein the access settings allow multiple access levels depending on the device ID.

10. The method of claim 5, further comprising:
receiving personal information specific to the second user;
receiving a device ID associated with the second user from a third user; and
prompting the second user to provide access settings to the second user's personal information.

11. The method of claim 5, further comprising:
modifying information available to the second user based on access setting changes made by the first user.

12. A device for exchanging user information comprising:
a selector that configures the device to send one of a plurality of device IDs stored on the device;
a first data connection that sends the selected device ID to a second device and receives a device ID corresponding to the second device;
a data storage that stores the plurality of device IDs and the received device ID within the device; and
a second data connection that sends device IDs stored in the data storage to an external database that stores user information corresponding to each of the device IDs.

13. The device of claim 12, further comprising:
an indicator that communicates to a user that a data transfer over the first data connection or the second data connection is in progress, completed, or failed.

14. The device of claim 12, wherein the external database is accessed through a website.

15. The device of claim 12, wherein each of the plurality of device IDs corresponds to a user profile.

16. The device of claim 12, wherein each of the plurality of device IDs corresponds to an access level to a user's information.

17. The device of claim 12, wherein the selector, first data connection, data storage, and second data connection are integrated into one of a cellular telephone and a personal data assistant (PDA).

18. The device of claim 12, wherein the first data connection is a wireless connection.

19. The device of claim 12, wherein the user information includes payment data.

20. The device of claim 12, wherein the user information includes contact data.
